(19) United States
(12) Patent Application Publication
(10) Pub. No.: US 2009/0159685 A1
(43) Pub. Date: Jun. 25, 2009

(54) Optimizing Optical Quality of a Sensor in a Bar Code Reader

(75) Inventors: Tsi David Shi, Stony Brook, NY (US); Rong Liu, Selden, NY (US); Ming Yu, South Setauket, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 11/961,338

(22) Filed: Dec. 20, 2007

(51) Int. Cl. G06K 7/10

(52) U.S. Cl. 235/462.42

(57) ABSTRACT

An exemplary barcode reader includes an imaging system that includes a light monitoring pixel array for converting light reflected from a target into electrical signals, and an optical system having one or more focusing lenses positioned with respect to the pixel array to transmit an image of a target object toward said pixel array. An illumination system comprising a light source for illuminating a the target within a field of view defined by the optical system. A filter is disposed adjacent the focusing lens and passing illumination with a wavelength less than about 700 nanometers to the pixel array and impedes the passage of light having a wavelength greater than this value.

### FIELD OF THE INVENTION

The present invention relates to a filter for an imaging-based bar code reader.

### BACKGROUND

Various electro-optical systems have been developed for reading optical indicia, such as bar codes. A bar code is a coded pattern of graphical indicia comprised of a series of bars and spaces having differing light reflecting characteristics. The pattern of the bars and spaces encode information. In certain bar codes, there is a single row of bars and spaces, typically of varying widths. Such bar codes are referred to as one dimensional bar codes. Other bar codes include multiple rows of bars and spaces, each typically having the same width. Such bar codes are referred to as two dimensional bar codes. Devices that read and decode one and two dimensional bar codes utilizing imaging systems that image and decode imaged bar codes are typically referred to as imaging-based bar code readers or bar code scanners.

Imaging systems include charge coupled device (CCD) arrays, complementary metal oxide semiconductor (CMOS) arrays, or other imaging pixel arrays having a plurality of photosensitive elements or pixels. An illumination system comprising light emitting diodes (LEDs) or other light source directs illumination toward a target object, e.g., a target bar code. Light reflected from the target bar code is focused through a lens of the imaging system onto the pixel array. Thus, an image of a field of view of the focusing lens is focused on the pixel array. Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals and attempts to decode the imaged bar code.

United States published patent application entitled “Ambient Light Shield and Color Filter for Imaging-Based Bar Code Reader”, publication no 2007/0199996 describes an ambient illumination shielding apparatus. That application also describes a filter disposed in proximity to an imaging system that passes illumination within a predetermined wavelength range to a sensor pixel array. This published patent application is incorporated herein by reference.

### SUMMARY

Many CMOS sensors are sensitive to deep red and infrared wavelengths. This high sensitivity is undesired because imaging lens are optimized for visible light of shorter wavelength. Since infrared light has longer wavelength than visible light, the lenses tend to focus at greater lengths resulting in color separating and bigger diffraction spot size. In addition, longer wavelengths deplete farther in the pixel substrate, resulting in more leakage current, and thus reduce effective pixel resolution per sensor module. Moreover, longer wavelengths result in pixel cross talk since they are focused at a greater distance. The net result is reduced image contrast making the resultant image less sharp.

An exemplary barcode reader includes an imaging system that includes a light monitoring pixel array for converting light reflected from a target into electrical signals, and an optical system having one or more focusing lenses positioned with respect to the pixel array to transmit an image of a target object toward said pixel array. An illumination system comprising a light source for illuminating a the target within a field of view defined by the optical system.

A filter is disposed in proximity to the imaging system for passing illumination within a predetermined wavelength range to the pixel array and impeding the passage of illumination outside of the predetermined wavelength range. The exemplary filter passes light in the visible range and impedes or blocks the passage of light in the infrared range.

These and other objects, advantages, and features of the exemplary embodiment of the invention are described in detail in conjunction with the accompanying drawings.

### BRIEF DESCRIPTION OF THE DRAWINGS

FIG. 1 is a schematic side elevation view of an imaging-based bar code reader of the present invention;

FIG. 2 is a schematic front elevation view of the imaging-based bar code reader of FIG. 1;

FIG. 3 schematic sectional view of a portion of the imaging-based bar code reader of FIG. 1 showing the scanner head and one embodiment of an ambient illumination shielding apparatus of the present invention;

FIG. 4 is a block diagram of an imaging-based bar code reader of FIG. 1;

FIG. 5 is a graph showing quantum efficiency for a CMOS imaging sensor; and

FIGS. 6-8 depict a bar code reader 10 lens assembly having a filter coated on to a sensor facing surface of that lens assembly.

### DETAILED DESCRIPTION

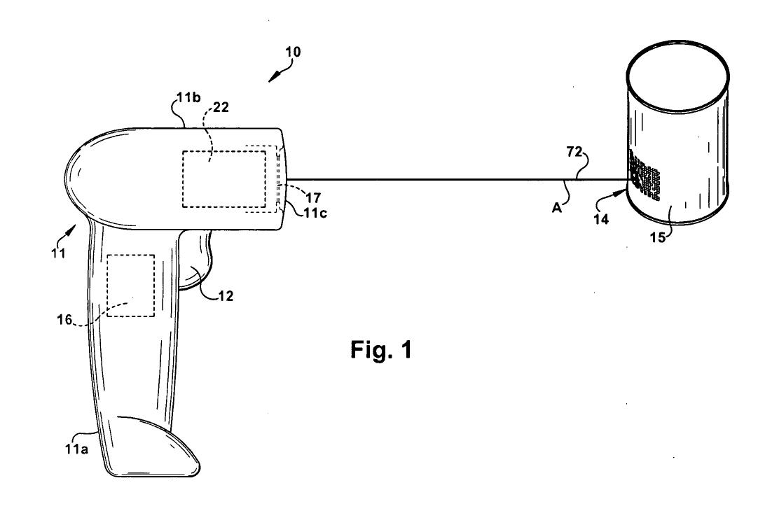

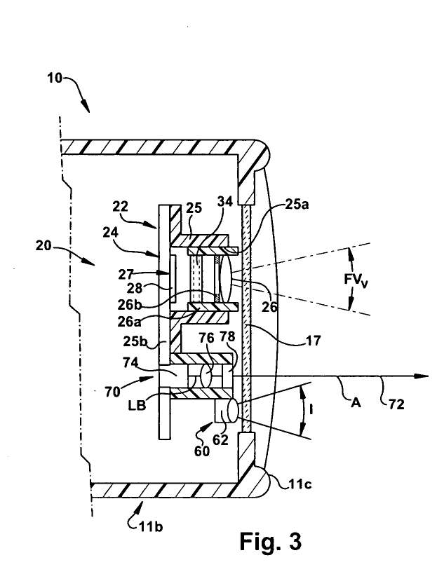

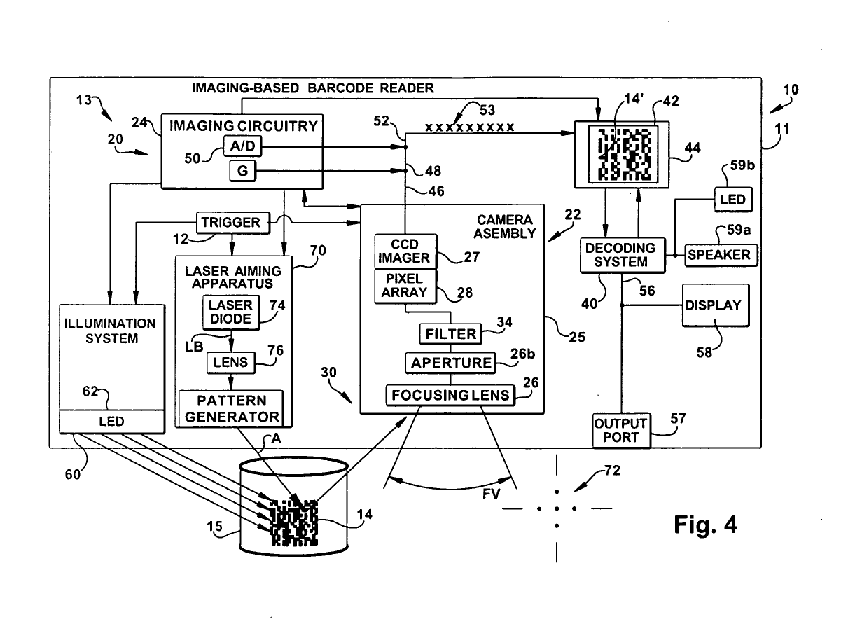

An imaging-based reader, such as an imaging-based bar code reader, is shown schematically at 10 in FIG. 1. The bar code reader 10, in addition to imaging and decoding both 1D and 2D bar codes and postal codes, is also capable of capturing images and signatures. The bar code reader 10 includes an imaging system 20 and a decoding system 40 (FIGS. 3 and 4) for capturing image frames of a field of view FV of the imaging system 20 and decoding encoded indicia within a captured image frame. The bar code reader 10 includes a housing 11 supporting the imaging and decoding systems 20, 40 within an interior region of the housing 11.

The imaging system 20 has an imaging camera assembly 22 and associated imaging circuitry 24. The imaging camera 22 includes a housing 25 supporting a focusing lens 26 and an imager 27 comprising a pixel array 28. The imager 27 is enabled during an exposure period to capture an image of the field of view FV of the focusing lens 26.

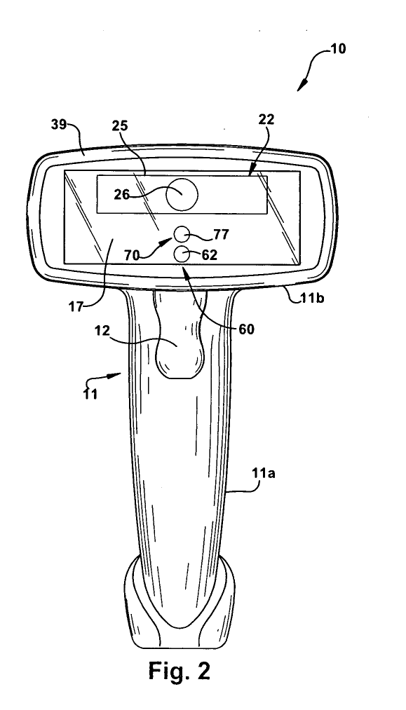

In one preferred embodiment of the present invention, the bar code reader 10 is a hand held portable reader encased in the pistol-shaped housing 11 adapted to be carried and maneuvered by a user. As is best seen in FIGS. 1 and 2, the bar code reader housing 11 includes a generally upright gripping portion 11a adapted to be grasped by a user's hand and a horizontally extending scanning head 11b which supports the imaging assembly 20, an illumination assembly 60 and an aiming apparatus 70. At the intersection of gripping portion 11a and the scanning head 11b is a trigger 12 coupled to bar code reader circuitry 13 for initiating reading of target indicia, such as a target bar code 14, when the trigger 12 is pulled or pressed. The bar code reader circuitry 13, the imaging system 20 and the decoding circuitry 40 are coupled to a power supply 16, which may be in the form of an on-board battery or a connected off-board power supply. If powered by an off-board power supply, the scanner 10 may be a stand-alone unit or have some or all of the scanner's functionality provided by a connected host device. When actuated to read the target bar code 14, the imaging system 20 images the target bar code 14 and the decoding system 40 decode a digitized image 14′ (shown schematically in FIG. 4) of the target bar code 14.

The imaging system 20 includes the imaging circuitry 24 and decoding circuitry 40 for decoding the imaged target bar code 14′ (shown schematically in FIG. 4) within an image frame 42 stored in a memory 44. The imaging and decoding circuitry 24, 40 may be embodied in hardware, software, firmware, electrical circuitry or any combination thereof. The imaging circuitry 24 may be disposed within, partially within, or external to the camera assembly housing 25. Shown schematically in FIG. 4, the imaging camera housing 25 is supported with the scanning head 11b of the housing 11 and receives reflected illumination from the target bar code 14 through a transparent window 17 supported by the scanning head 11b. The focusing lens 26 is supported by a lens holder 26a. The camera housing 25 defines a front opening 25a that supports and seals against the lens holder 26a so that the only illumination incident upon the sensor array 28 is illumination passing through the focusing lens 26. Depending on the specifics of the camera assembly 22, the lens holder 26a may slide in and out within the camera housing front opening 25a to allow dual focusing under the control of the imaging circuitry 24 or the lens holder 26a may be fixed with respect to the camera housing 25 in a fixed focus camera assembly. The lens holder 26a is typically made of metal. A back end of the housing 25 may be comprised of a printed circuit board 25b, which forms part of the imaging circuitry 24 and may extend beyond the housing 25 to support the illumination system 60 and the laser aiming apparatus 70.

The imaging system 20 includes the imager 27 of the imaging camera assembly 22. The imager 27 comprises a charged coupled device (CCD), a complementary metal oxide semiconductor (CMOS), or other imaging pixel array, operating under the control of the imaging circuitry 24. In one exemplary embodiment, the pixel array 28 of the CCD imager 27 comprises a two dimensional (2D) mega pixel array with a typical size of the pixel array being on the order of 1280×1024 pixels. The pixel array 28 is secured to the printed circuit board 25b, in parallel direction for stability.

As is best seen in FIG. 3, the focusing lens 26 focuses light reflected from the target bar code 14 through an aperture 26b onto the pixel/photosensor array 28 of the CCD imager 27. Thus, the focusing lens 26 focuses an image of the target bar code 14 (assuming it is within the field of view FV) onto the array of pixels comprising the pixel array 28. Electrical signals are generated by reading out of some or all of the pixels of the pixel array 28 after an exposure period. After the exposure time has elapsed, some or all of the pixels of pixel array 28 are successively read out thereby generating an analog signal 46 (FIG. 4). In some sensors, particularly CMOS sensors, all pixels of the pixel array 28 are not exposed at the same time, thus, reading out of some pixels may coincide in time with an exposure period for some other pixels.

The analog image signal 46 represents a sequence of photosensor voltage values, the magnitude of each value representing an intensity of the reflected light received by a photosensor/pixel during an exposure period. The analog signal 46 is amplified by a gain factor, generating an amplified analog signal 48. The imaging circuitry 24 further includes an analog-to-digital (A/D) converter 50. The amplified analog signal 48 is digitized by the A/D converter 50 generating a digitized signal 52. The digitized signal 52 comprises a sequence of digital gray scale values 53 typically ranging from 0-255 (for an eight bit processor, i.e., 28=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness).

The digitized gray scale values 53 of the digitized signal 52 are stored in the memory 44. The digital values 53 corresponding to a read out of the pixel array 28 constitute the image frame 42, which is representative of the image projected by the focusing lens 26 onto the pixel array 28 during an exposure period. If the field of view FV of the focusing lens 26 includes the target bar code 14, then a digital gray scale value image 14′ of the target bar code 14 would be present in the image frame 42.

The decoding circuitry 40 operates on the digitized gray scale values 53 of the image frame 42 and attempts to decode any decodable image within the image frame, e.g., the imaged target bar code 14′. If the decoding is successful, decoded data 56, representative of the data/information coded in the bar code 14 is then output via a data output port 57 and/or displayed to a user of the reader 10 via a display 58. Upon achieving a good “read” of the bar code 14, that is, the bar code 14 was successfully imaged and decoded, a speaker 59a and/or an indicator LED 59b is activated by the bar code reader circuitry 13 to indicate to the user that the target bar code 14 has successfully read, that is, the target bar code 14 has been successfully imaged and the imaged bar code 14′ has been successfully decoded.

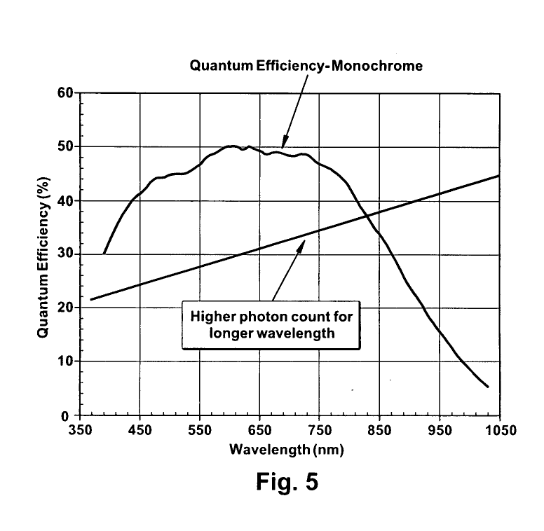

The bar code reader 10 further includes the illumination assembly 60 for directing a beam of illumination to illuminate the target bar code 14 and the aiming apparatus 70 for generating a visible aiming pattern 72 (FIG. 5) to aid the user in properly aiming the reader at the target bar code 14. The illumination assembly 60 and the aiming apparatus 70 operate under the control of the imaging circuitry 24. As can best be seen in FIGS. 2 and 3, in one preferred embodiment, the illumination assembly 60 is a single LED 62 producing a wide illumination angle to completely illuminate the target bar code 14.

The LED 62 is supported within the scanning head 11b just behind the transparent window 17 and face forwardly, that is, toward the target bar code 14. The LED 62 is positioned away from the focusing lens 26 to increase the illumination angle (shown schematically as I in FIG. 4) produced by the LED 62. Preferably, the illumination provided by the illumination assembly 60 is intermittent or flash illumination as opposed to continuously on illumination to save on power consumption.

In one exemplary embodiment, the aiming apparatus 70 is a laser aiming apparatus. The aiming pattern 72 may be a pattern comprising a single dot of illumination, a plurality of dots and/or lines of illumination or overlapping groups of dots/lines of illumination (FIG. 5). The laser aiming apparatus 70 includes a laser diode 74, a focusing lens 76 and a pattern generator 77 for generating the desired aiming pattern 77. The laser diode 74, the lens 76 and the pattern generator are supported by a lens holder 78 which extends from the printed circuit board 25b. The aiming apparatus 70 is supported in the scanning head 11b and the aiming pattern exits the head through the transparent window 17.

Operating under the control of the imaging circuitry 24, when the user has properly aimed the reader 10 by directing the aiming pattern 72 onto the target bar code 14, the aiming apparatus 70 is turned off when an image of the target bar code 14 is acquired such that the aiming pattern 72 does not appear in the captured image frame 42. Intermittantly, especially when the scanner imaging circuitry 24 is transferring the captured image frame 42 to memory 44 and/or when processing the image, the aiming apparatus 70 is turned back on. If the decoding circuitry 40 cannot decode the imaged bar code 14′ and the user in the mean time has not released the trigger 12, the process of acquiring an image of the target bar code 14 set forth above is repeated.

### Infrared Filter

Infrared light has longer wavelengths than visible light and less photon energy. For a fixed amount of energy there are more infrared photons than visible photons. Assuming the quantum efficiency curve is flat; this would mean higher sensor sensitivity for infrared light. The curve in FIG. 5 shows typical quantum efficiency for a CMOS sensor. Notice that when it is superimposed on top of a linearly increasing photon count curve for longer wavelength light, the resulting sensor sensitivity is higher for longer wavelength light.

If the lens 26 is not optimized for both visible and infrared light, light with longer wavelengths will focus farther than those with short wavelengths. Thus, the effective spot size is larger and image contrast is lower. The situation is worse with higher sensor sensitivity for longer wavelength light.

Moreover, long wavelength light, particularly infrared, will deplete farther in the pixel substrate, resulting in more leakage current. This will reduce effective pixel resolution or pixel per module. Sensors have also pixel crosstalk issues as result of the use of lenslet arrays that focus steep angle light bundles and missing the proper pixel. This issue is also made worse with longer wavelength light since it focuses farther than light in the visible range. An infrared cutter or short-pass filter 34 reduces exposure to long wavelength light, in particular the infrared light.

The exemplary bar code reader 10 has a filter 34 positioned between the focusing lens 26 and the photosensor array 28. Positioning the filter 34 in space between the photosensor array 28 and the focusing lens 26 does not detrimentally affect the functioning of the focusing lens 26 (although the lens 26 may have to be positioned slightly further away from the photosensor array 28 to maintain the same focus onto the photosensor array 28). The filter 34 would most preferably block light having a wavelength of greater than 700 nm. An appropriate interference filter may be obtained from various optical suppliers such as Edmund Optics, Barrington, N.J. 08007 (www.edmundoptics.com).

The filter 34 is shown in FIGS. 3 and 4 located between the focusing lens 26 and the photosensor array 28. It should be appreciated, however, that the filter 34 may be disposed upstream, that is, outwardly of the focusing lens 26. Additionally, the filter 34 may be incorporated into the transparent window 17 (or a portion of the transparent window 17 adjacent the reader housing) thereby eliminating the need for having two separate components for the window 17 and the filter 34.

### Imaging Lens Assembly 130

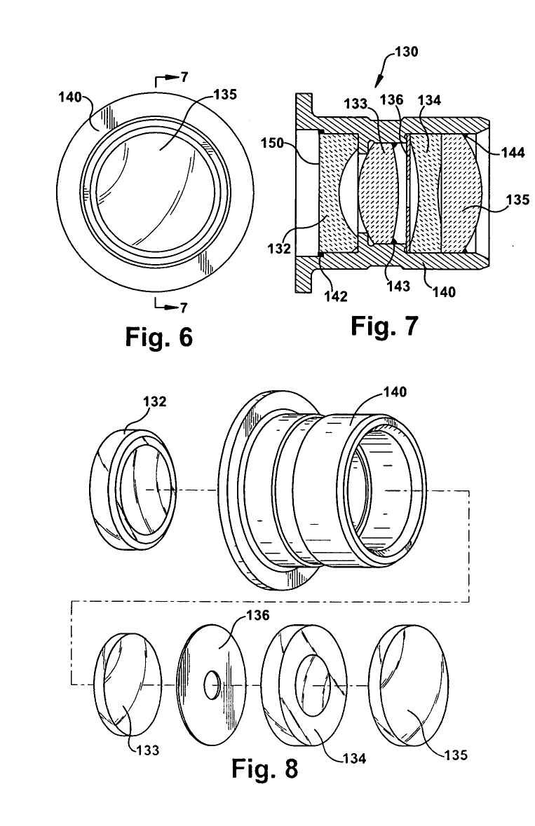

A presently preferred bar code reader 10 has a filter coated on to a sensor facing surface of a lens assembly 130 shown in FIGS. 6-8. The focusing lens assembly 130 focuses light reflected and scattered from the object of interest such as the target bar code 14 onto the sensor array 28, thereby focusing an image of the target bar code 14 (assuming it is within the field of view FV) onto the sensor array 28. The imaging lens assembly 130 depicted in the figures is advantageously compact. A similar compact lens assembly is a described more fully in pending U.S. patent application Ser. No. 11/731,835 entitled “Compact Imaging Lens Assembly for an Imaging Based Bar Code Reader” filed Mar. 30, 2007 which is assigned to the assignee of the present application and which is incorporated herein by reference.

As seen in the Figures, the imaging lens assembly 130 includes four lenses 132, 133, 134, 135 and an intermediate front aperture stop 136 mounted in a holder 140. The aperture stop 131 defines a circular or rectangular opening, which limits the light impinging upon the sensor array 28. Additional details of the functionality of a similar lens assembly is described in the aforementioned pending United States patent application.

The four lenses 132-135 of the lens assembly 130 are supported in a generally cylindrical lens holder 140, which may be fabricated of metal or plastic. The lens holder 37, in turn is supported by the camera housing 25 which extends to the printed circuit board 25b. In addition to supporting the lens holder 37, the camera housing protects the sensor array 28 from ambient illumination. Annular seals 142-144 adhesively seal the lenses to the holder 140.

The rearmost lens includes an outer coating 150 that covers an entire generally planar rear surface of the lens assembly 130. The coating 150 is applied using the techniques of thin-film filter fabrication. A thin film filter is a multi-layer, light filtering coating that is built up layer by layer on a substrate such as clear plastic by evaporative deposition or other method. When complete, the thin film coating has appropriate wavelength blocking characteristics. Specifics on fabricating a thin film bandpass filter may be found in a book entitled Thin-Film Optical Filters, 3^{rd} Edition, by H. Angus Macleod, Institute of Physics Publishing, Dirac House, Temple Back, Bristol, UK Bs1 6BE, copyright 2110, ISBN 0 7503 06882. The aforementioned book is incorporated in its entirety herein by reference.

While the present invention has been described with a degree of particularity, it is the intent that the invention includes all modifications and alterations from the disclosed design falling within the spirit or scope of the appended claims.

1. A barcode reader for imaging a target comprising:
an imaging system that includes a light monitoring pixel array for converting light reflected from a target into electrical signals;
an optical system having a plurality of focusing lenses positioned with respect to the pixel array to transmit an image of the target toward said pixel array;
an illumination system comprising a light source for illuminating the target within a field of view defined by the optical system;
a thin film filter deposited onto a surface of one focusing lens of said plurality of focusing lenses, said one focusing lens located closest to the pixel array for passing visible light below a predetermined wavelength range to the pixel array and impeding the passage of infrared light above the predetermined wavelength range.

2. (canceled)

3. The apparatus of claim 1 wherein the thin filter impedes infrared light having a wavelength above 700 nanometers.

4-5. (canceled)

6. The apparatus of claim 1 wherein the thin film filter is deposited on a surface of the focusing lens facing the pixel array.

7. (canceled)

8. The apparatus of claim 1 wherein the lens closest the pixel array includes a generally planar surface to which the thin film filter is applied.

9. A bar code reader comprising:
an illumination system for generating illumination directed at a target bar code;
an imaging system including a pixel array, and a plurality of focusing lenses for focusing an image of the target bar code onto the pixel array; and
a thin film filter deposited onto a surface of one focusing lens of the plurality of said lenses, said one focusing lens positioned closest to the pixel array that passes light within a visible range to the pixel array and impedes the passage of infrared light having a wavelength above the visible range.

10. (canceled)

11. The bar code reader of claim 9 wherein the filter impedes light having a wavelength above 700 nanometers.

12-14. (canceled)

15. The barcode reader of claim 9 wherein the thin film filter is deposited on a lens facing the pixel array.

16. A method for imaging a target comprising:
positioning a light monitoring pixel array within a housing for converting light reflected from a target into electrical signals;
providing a plurality of focusing lenses with respect to the pixel array to transmit an image of the target toward said pixel array;
illuminating a the target within a field of view defined by the one or more focusing lenses;
depositing a thin film filter onto a focusing lens closest to the pixel array to impede the passage of infrared light having a wavelength above a visible range from reaching the light monitoring pixel array; and
evaluating an output from the pixel array to determine a characteristic of the target.

17. (canceled)

18. The method of claim 16 wherein infrared light having a wavelength greater than about 700 nanometers is impeded from reaching the pixel array due to said thin film filter.

19-20. (canceled)
